(19) United States
(12) Patent Application Publication
(10) Pub. No.: US 2023/0315475 A1
(43) Pub. Date: Oct. 5, 2023

(54) MANAGING LARGE TAGE HISTORIES

(71) Applicant: ADVANCED MICRO DEVICES, INC., SANTA CLARA, CA (US)

(72) Inventors: ANTHONY JARVIS, BOXBOROUGH, MA (US); THOMAS CLOUQUEUR, BOXBOROUGH, MA (US)

(21) Appl. No.: 17/708,247

(22) Filed: Mar. 30, 2022

(51) Int. Cl. G06F 9/38; G06F 9/30

(52) U.S. Cl. CPC G06F 9/3844; G06F 9/30029; G06F 9/3804

(57) ABSTRACT

A tagged geometric (TAGE) branch predictor for managing large TAGE branch histories, including: logic that maintains a global branch history including a circular buffer; logic that maintains a plurality of TAGE tables; and logic that maintains a plurality of folded branch histories, wherein each folded branch history of the plurality of folded branch histories corresponds to a TAGE table of the plurality of TAGE tables, wherein the folded branch histories are each based on different length subsets of the global branch history.

### BACKGROUND

Tagged geometric (TAGE) branch predictors use a combination of tagged TAGE table entries and increasing history lengths in order to generate predictions for a branch instruction. To do so, the TAGE branch predictor maintains a single, large global branch history describing whether previously encountered branches were taken or not taken. Portions of the global branch history of geometrically increasing lengths are used to index TAGE tables to generate the prediction. As the size of the global branch history increases, folding can be used to calculate the indexes for the TAGE tables. However, generating these folded values are computationally intensive and require significant computation time to build for each prediction cycle.

### BRIEF DESCRIPTION OF THE DRAWINGS

FIG. 1 is a block diagram of an apparatus including an example TAGE branch predictor for managing large TAGE histories according to some implementations.

FIG. 2 is a block diagram of an example TAGE branch predictor for managing large TAGE histories according to some implementations.

FIG. 3 is a diagram of an example TAGE table for managing large TAGE histories according to some implementations.

FIG. 4 is a diagram of an example global branch history for managing large TAGE histories according to some implementations.

FIG. 5 is a flowchart of an example computer for managing large TAGE histories according to some implementations.

FIG. 6 is a flowchart of an example method for managing large TAGE histories according to some implementations.

FIG. 7 is a flowchart of another example method for managing large TAGE histories according to some implementations.

FIG. 8 is a flowchart of another example method for managing large TAGE histories according to some implementations.

### DETAILED DESCRIPTION

Tagged geometric (TAGE) branch predictors maintain a global branch history for generating predictions. Portions of the global branch history of geometrically increasing lengths are used to index TAGE tables to generate the prediction. As the size of the global branch history increases, folding can be used to calculate the indexes for the TAGE tables. However, generating these folded values are computationally intensive and require significant computation time to build for each prediction cycle.

The present specification sets forth various implementations for managing large TAGE histories. In some implementations, a tagged geometric (TAGE) branch predictor for managing large TAGE histories is disclosed. Such a TAGE branch predictor includes a global branch history including a circular buffer, a plurality of TAGE tables, and a plurality of folded branch histories. Each folded branch history of the plurality of folded branch histories corresponds to a TAGE table of the plurality of TAGE tables. The folded branch histories are each based on different length subsets of the global branch history.

In some implementations, the TAGE branch predictor generates the plurality of folded branch histories by subdividing, for each of TAGE table of the plurality of TAGE tables, a corresponding subset of the global branch history into equal length portions, and generating, for each TAGE table of the plurality of TAGE tables, a corresponding folded branch history by applying a function to the equal length portions. In some implementations, the function includes an XOR function. In some implementations, the TAGE branch predictor updates the plurality of folded branch histories without regenerating the plurality of folded branch histories from the global branch history. In some implementations, the TAGE branch predictor generates, for a branch prediction cycle, a checkpoint for the plurality of folded branch histories. In some implementations, the TAGE branch predictor restores, in response to a flush for the branch prediction cycle, the plurality of folded branch histories based on the checkpoint. In some implementations, the different length subsets of the global branch history are of geometrically increasing length.

The present specification also describes various implementations for a method of managing large TAGE histories. Such methods include storing a global branch history of a tagged geometric (TAGE) branch predictor including a circular buffer and generating, for each TAGE table of a plurality of TAGE tables, a folded branch history of a plurality of folded branch histories. The folded branch histories are each based on different length subsets of the global branch history. Such methods also include storing the plurality of folded branch histories.

In some implementations, generating the plurality of folded branch histories includes subdividing, for each of TAGE table of the plurality of TAGE tables, a corresponding subset of the global branch history into equal length portions, and generating, for each TAGE table of the plurality of TAGE tables, a corresponding folded branch history by applying a function to the equal length portions. In some implementations, the function includes an XOR function. In some implementations, the method further includes updating the plurality of folded branch histories without regenerating the plurality of folded branch histories from the global branch history. In some implementations, the method further includes generating, for a branch prediction cycle, a checkpoint for the plurality of folded branch histories. In some implementations, the method further includes restoring, in response to a flush for the branch prediction cycle, the plurality of folded branch histories based on the checkpoint. In some implementations, the different length subsets of the global branch history are of geometrically increasing length.

Also described in this specification are various implementations of an apparatus for managing large TAGE histories. Such an apparatus includes computer memory and a processor operatively coupled to the computer memory. The processor includes a TAGE branch predictor. The TAGE branch predictor includes a global branch history, a plurality of TAGE tables, and a plurality of folded branch histories. The global branch history also includes a circular buffer. Each folded branch history of the plurality of folded branch histories corresponds to a TAGE table of the plurality of TAGE tables and the folded branch histories are each based on different length subsets of the global branch history.

In some implementations, the TAGE branch predictor generates the plurality of folded branch histories by: subdividing, for each of TAGE table of the plurality of TAGE tables, a corresponding subset of the global branch history into equal length portions, and generating, for each TAGE table of the plurality of TAGE tables, a corresponding folded branch history by applying a function to the equal length portions. In some implementations, the function is an XOR function. In some implementations, the TAGE branch predictor updates the plurality of folded branch histories without regenerating the plurality of folded branch histories from the global branch history. In some implementations, the TAGE branch predictor generates, for a branch prediction cycle, a checkpoint for the plurality of folded branch histories. In some implementations, the TAGE branch predictor restores, in response to a flush for the branch prediction cycle, the plurality of folded branch histories based on the checkpoint.

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows include implementations in which the first and second features are formed in direct contact, and also include implementations in which additional features be formed between the first and second features, such that the first and second features are not in direct contact. Further, spatially relative terms, such as “beneath,” “below,” “lower,” “above,” “upper,” “back,” “front,” “top,” “bottom,” and the like, are used herein for ease of description to describe one element or feature's relationship to another element(s) or feature(s) as illustrated in the figures. Similarly, terms such as “front surface” and “back surface” or “top surface” and “back surface” are used herein to more easily identify various components, and identify that those components are, for example, on opposing sides of another component. The spatially relative terms are intended to encompass different orientations of the device in use or operation in addition to the orientation depicted in the figures.

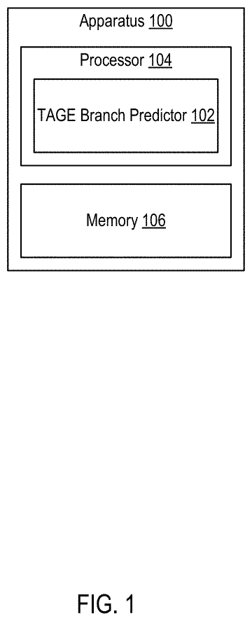

FIG. 1 is a block diagram of an apparatus 100 that includes a tagged geometric (TAGE) branch predictor 102 for managing large TAGE histories according to some implementations. The apparatus 102 can be implemented as a variety of computing devices, including personal computers, mobile devices, servers, systems-on-a-chip (SoCs), hardware accelerators, and the like. The apparatus 100 in the example of FIG. 1 includes a processor 104 such as a central processing unit (CPU) or other processor 104 as can be appreciated. The apparatus 100 also includes memory 106 operatively coupled to the processor 104. The memory 106 includes, for example, volatile memory such as random access memory (RAM), non-volatile memory, disk-based storage, or combinations thereof.

The processor 104 includes a TAGE branch predictor 102 for managing large TAGE histories according to some implementations described in further detail below. The TAGE branch predictor 102 performs a branch prediction on instructions provided to the processor 104 for execution (e.g., instructions loaded from memory 106). The TAGE branch predictor 102 uses a TAGE algorithm to perform branch prediction as will be described in further detail below.

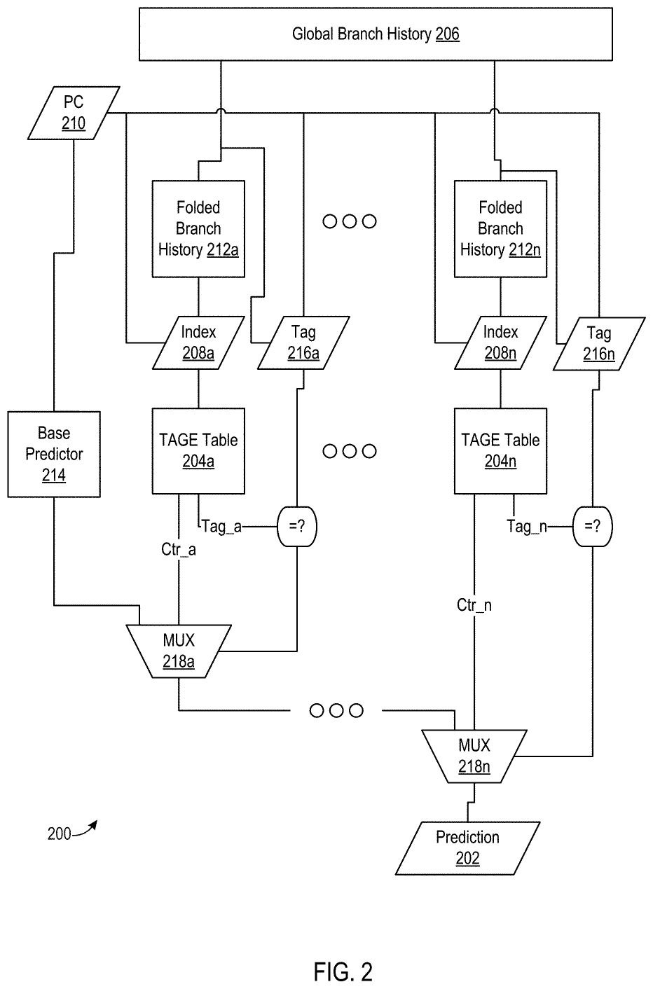

FIG. 2 is a block diagram of a non-limiting example TAGE branch predictor configured according to various implementations of the present disclosure. The example TAGE branch predictor 200 can be implemented in a variety of processors, cores, and other computer hardware components as can be appreciated. The TAGE branch predictor 200 uses a TAGE branch prediction algorithm as would be appreciated by one skilled in the art to generate, for a given branch instruction, a prediction 202. The prediction 202 is a prediction of whether or not a branch in the branch instruction will be taken. In other words, the prediction 202 is a prediction of whether or not a particular condition that will trigger a conditional branch will be satisfied.

To generate the prediction 202, the TAGE branch predictor 200 maintains multiple TAGE tables 204a-n. Each TAGE table 204a-n is a logical table that includes a plurality of entries. As will be described in further detail below, each TAGE table 204a-n is indexed based on an increasingly long portion of branch prediction history, with the utilized lengths of branch prediction history increasing according to a geometric sequence.

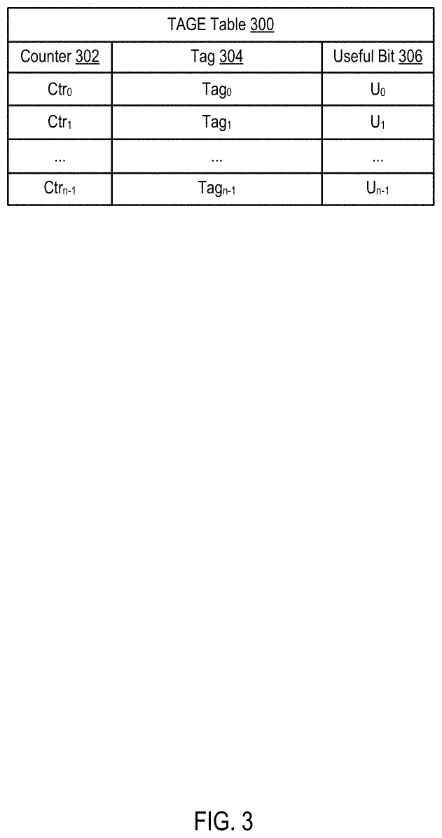

For further explanation of a TAGE TABLE, FIG. 3 sets forth an example TAGE table similar to those mentioned above. As is shown in the example TAGE table 300 of FIG. 3, each entry of the TAGE table 300 includes a counter 302 and a tag 304. The use of the counter 302 and tag 304 for a given entry in generating the prediction is described in further detail below. Each entry also includes a useful bit 306 that, if set, prevents modification of the corresponding entry. In some implementations, the useful bit 306 is capable of being overridden to allow modification.

Returning to FIG. 2, the history used by the TAGE branch predictor 200 is shown as the global branch history 206. The global branch history 206 is a data structure or portion of memory including a plurality of entries each indicating whether a branch was taken or not taken. As an example, each entry is a single bit, with a “1” indicating a taken branch and a “0” indicating a non-taken branch. For a global branch history 206 with N entries, the global branch history 206 then stores the N-most recent branch decisions. In some implementations, the global branch history 206 includes a path history. A register value for a path history is shifted for all branch types so long as their direction is taken, typically shift by two or three bits at a time. Instead of shifting in the direction of a branch at the lowest position, a portion of the address of the last byte in the instruction is XORed into the register, allowing some overlap with the previous values at the low position.

As the global branch history 206 is of limited size, after the global branch history 206 is full, an oldest entry should be removed when a newest entry is added. In existing solutions, prediction branch histories 206 are stored using an N-bit shift register. When a new entry is added to the global branch history 206, the entire register is shifted by a single bit and a bit is stored at the new head of the register. The amount of power required to perform this bit shift increases as the size of the shift register increases. Accordingly, a large global branch history 206 using a shift register would require a large amount of power to shift the register for each update to the global branch history 206.

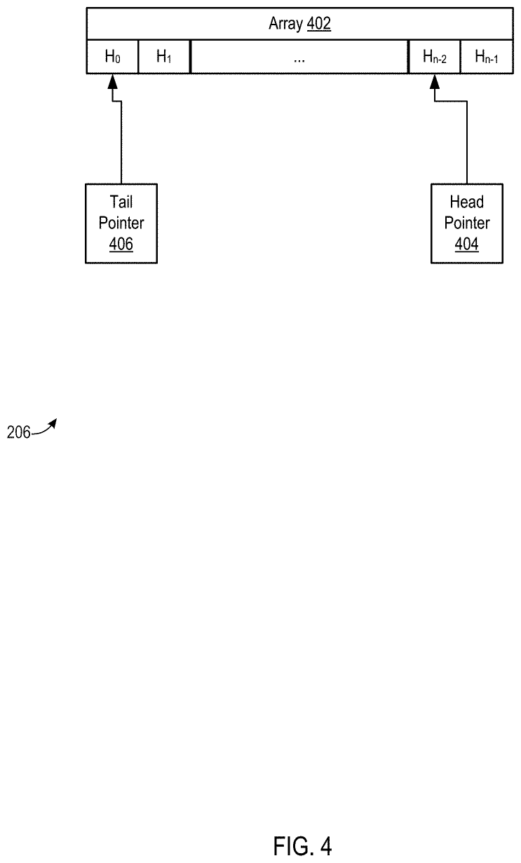

To address this concern, in some implementations, the global branch history 206 is instead implemented using an array, such as the array depicted in the example of FIG. 4. The array 402 as shown in FIG. is implemented, for example, as a latch array, a flip-flop array, as an allocated portion of static random access memory (SRAM), and the like. Each entry in the array 402 is a single bit. Instead of shifting entries as with a shift register, the global branch history (206 of FIG. 2, for example) maintains a head pointer 404 identifying a newest entry in the array 402 and a tail pointer 406 identifying an oldest entry in the array 402. In other words, the global branch history (206 of FIG. 2, for example) is implemented as a circular buffer. Although FIG. 4 shows the head pointer 404 identifying entry Hₙ₋₂ and the tail pointer 406 identifying entry H₀, one skilled in the art will appreciate that this is only for illustrative purposes and that the particular entries identified by the head pointer 404 and tail pointer 406 will change as the global branch history is updated.

Consider an example where the head pointer 404 identifies entry Hₙ₋₂ and the tail pointer 406 identifies entry H₀, with entry Hₙ₋₁ currently unused. An update to the global branch history 206 will then cause a value to be stored at entry Hₙ₋₁ and the head pointer 404 to be updated to identify the entry Hₙ₋₁. The array 402 is now full, with all entries storing a value for the global branch history. Another update will require an oldest value to be removed from the array 402. Accordingly, in response to another update, the tail pointer 406 will be updated to identify entry Hi, the head pointer 404 will be updated to identify entry H₀, and the value for the update will then be stored at entry H₀. Additional updates will continue to cause the head pointer 404 and tail pointer 406 to be updated, with the value for the latest update to be stored at the entry identified by the updated head pointer 404.

As will be appreciated by one skilled in the art, updating a global branch history implemented using an array 402, head pointer 404 and tail pointer 404 only requires modification of a single entry in the array 402 and updates to the head pointer 404 and, if the array 402 is full, the tail pointer 404. This provides considerable power savings when compared to shifting a shift register of sufficiently large size.

Again returning to FIG. 2, an entry for a given TAGE table 204a-n is identified using an index 208a-n. An index 208a-n is calculated as a function of the program counter (PC) 210 (e.g., identifying the address of the branch instruction subject to prediction) and a portion of the global branch history 206, with each TAGE table 204a-n having its corresponding index 208a-n calculated using portions of the global branch history 206 of geometrically increasing length. For example, the PC 210, or a subset of the bits of the PC 210, are combined with the bits of the global branch history 206 used for the given index 208a-n using a hash function, an exclusive-OR (XOR) function, or other function. Although the following discussion will use the term “hashing” when combining the PC 210 with bits from the global branch history 206, it is understood that this encompasses the use of XOR functions or other aggregate functions usable in combining the PC 210 with portions of the global branch history 206 to generate an index 208a-n.

As the number of global branch history 206 bits used for a given TAGE table 204a-n (hereinafter referred to as “history bits”) increases, the number of history bits used will exceed the number of bits needed to index a TAGE table 204a-n (e.g., to identify a particular entry in the TAGE table 204a). For example, a TAGE table 204a-n with 1024 entries only needs ten bits to identify any of the entries. Accordingly, before hashing the PC 210 with the history bits, in some implementations the used history bits are “folded” on themselves to generate a folded branch history 212a-n.

The history bits are “folded” by subdividing the history bits into portions of equal length (e.g., corresponding to the number of bits needed to identify an entry in the TAGE table 204a-n) and then applying an XOR function to combine each of the portions into a single portion. Assuming N history bits used for a given TAGE table 204a-n and assuming M bits are needed to identify an entry in the TAGE table 204a-n, the N history bits are divided into N/M portions of M bits and XOR-ed together to create a single folded branch history 212a-n of M bits. For example, assume that a given TAGE table 204a-n with 2024 entries (therefore needing 10 bits to index) uses 500 bits of the global branch history 206. These 500 bits are divided into fifty 10-bit portions. These fifty portions are then XOR-ed together to create a single 10-bit folded branch history 212a-n from which an index 208a-n is generated.

In some implementations, a folded branch history 212a-n for each TAGE table 204a-n is calculated from the global branch history 206 each time a branch prediction is to be performed. However, this requires significant computational and time resources, and would require a large number of XOR gates in order to be implemented in hardware as the size of the global branch history 206 grows. Instead, in some implementations, the TAGE branch predictor 200 includes allocated portions of memory to logically store the folded branch history 212a-n for each TAGE table 204a-n. When the global branch history 206 is updated, instead of recalculating the folded branch history 212a-n for each TAGE table 204a-n, the stored folded branch histories 212a-n are modified to reflect the update (e.g., by shifting or rotating the folded branch history 212a-n, modifying one or more bits in the shifted value, accessing particular bits in the global branch history 206 to calculate particular bits in the folded branch history 212a-n, etc.). Thus, the folded branch history 212a-n for each TAGE table 204a-n is maintained without the need to fully recalculate each folded branch history 212a-n on an update to the global branch history 206.

In addition to the TAGE tables 204a-n, the TAGE branch predictor 200 also maintains a base predictor 214. The base predictor 214 is a table of counters indexed using the PC 210 that will provide a default prediction 202 if no entries in the TAGE tables 204a-n match the calculated indexes 208a-n.

To generate a prediction 202 for a given branch instruction, the TAGE branch predictor 200 calculates, for each TAGE table 204a-n, a tag 216a-n. Each tag 216a-n is calculated as a function (e.g., by hashing, XOR-ing, and the like) of the PC 210 and the bits of the global branch history 206 used by the corresponding TAGE table 204a-n. Though the indexes 208a-n and tags 216a-n are both generated as a function of the PC 210, the particular functions used to calculate the indexes 208a-n and tags 216a-n are different. For example, in some implementations, tags 216a-n and indexes 208a-n are of different lengths. Accordingly, in some implementations, a tag 216a-n for a given TAGE table 204a-n is calculated by folding the bits of the global branch history 206 used by that TAGE table 204a-n using portions having a number of bits equal to the number of bits used in a given tag 216a-n.

For each TAGE table 204a-n, where an entry is found at the corresponding index 208a-n, a counter (such as counter 302 of FIG. 3) value is provided to a corresponding multiplexer (MUX) 218a-n, shown in FIG. 2 as Ctr_a, Ctr_n. Moreover, where an entry is found at the corresponding index 208a-n, a tag (such as tag 304 of FIG. 3) for the entry (shown as Tag_a, Tag_n) is compared to the calculated tag 216a-n. The result of the comparison is provided as a selector signal to the corresponding MUX 218a-n. Thus, where the tag for the entry is equal to the calculated tag 216a-n, the MUX 218a-n outputs the counter output by the MUX 218a-n. Where the tag for the entry is not equal to the calculated tag 216a-n, or no entry is found, the MUX 218a-n provides, as output, an input received from a preceding MUX 218a-n or, in the case of the first MUX 218a, an input from the base predictor 214. The output of the last MUX 218n then serves as the prediction 202. The global branch history 206 is updated to reflect the result of the prediction 202 (e.g., a new entry is added to indicate whether it is predicted that the branch will or will not be taken).

A processor or core including the TAGE branch predictor 200 will then speculatively fetch and execute instructions based on the provided prediction 202. For example, where the prediction 202 indicates that a branch is taken, instructions will be fetched and executed from the target of the branch. As another example, where the prediction 202 indicates that a branch is not taken, instructions will be fetched and executed as if the branch was not taken. In certain circumstances, the prediction 202 is incorrect (e.g., a misprediction). In other words, it was predicted that a branch would be taken but was not, or it was predicted that a branch would not be taken but was. Accordingly, an instruction pipeline must be flushed and instructions fetched and executed from the correct point in the instruction cycle. Pipeline flushes also occur for reasons other than mispredicts, such as serialization requirement or occurrence of some error in the instruction stream.

Part of a flush will include restoring the TAGE branch predictor to a state prior to the flush (e.g., to a state used to generate the incorrect prediction 202 for the branch instruction) and then update the state to reflect the actual action taken for the branch instruction. For example, the global branch history 206 is rolled back by a number of updates performed including and after the incorrect prediction 202. Where folded branch histories 212a-n are stored and maintained, the folded branch histories 212a-n are restored to states corresponding to the rolled back global branch history 206.

In order to resume performing branch predictions, the TAGE branch predictor 200 needs the indexes 208a-n sooner in the prediction cycle than the tags 216a-n. As described herein, a prediction cycle (e.g., a branch prediction cycle), is the process of generating a prediction 202 for a given branch instruction. Thus, each branch instruction subject to prediction by the TAGE branch predictor 200 has its own branch prediction cycle. Accordingly, in some implementations, to reduce the time required to restore folded branch histories 212a-n, the TAGE branch predictor 200 generates, in response to receiving a branch instruction for prediction (e.g., every prediction cycle), a checkpoint storing a state of each of the folded branch histories 212a-n.

For example, in some implementations, the TAGE branch predictor 200 saves checkpoints for some number of most recent prediction cycles such that, if a flush occurs, the folded branch histories 212a-n are restored from the checkpoint corresponding to the mispredicted branch instruction. The global branch history 206 and the folded branch histories 212a-n are then updated to reflect the actual branch path taken instead of the previously generated prediction 202. At the next prediction cycle, the indexes 208a-n are then recalculated from the restored folded branch histories 212a-n. As the tags 216a-n are needed later in the prediction cycle, the tags 216a-n need not be saved in a checkpoint and are recalculated from the global branch history 206.

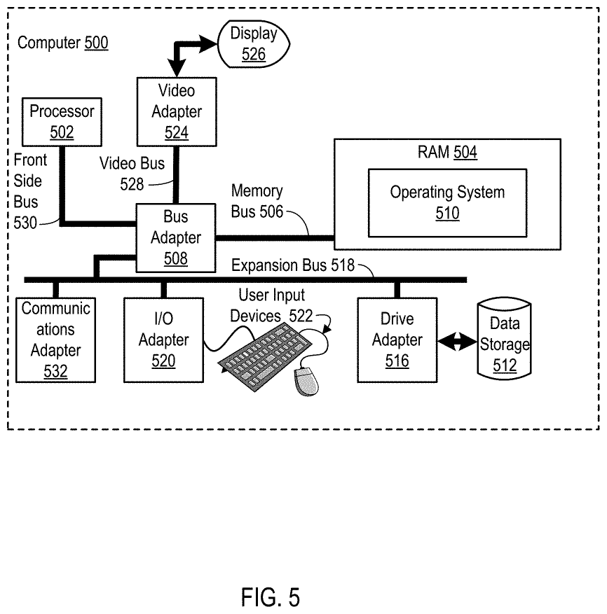

In some implementations, the TAGE branch predictor 200 of FIG. 2 is implemented in a computer. As such, FIG. 5 sets forth the a block diagram of an example computer 500. In the example of FIG. 5, a TAGE branch predictor is implemented in at least one processor 502. In addition to at least one processor 502, the computer 500 of FIG. 5 includes random access memory (RAM) 504 which is connected through a high speed memory bus 506 and bus adapter 508 to processor 502 and to other components of the computer 500. Stored in RAM 504 is an operating system 510. The operating system 510 in the example of FIG. 5 is shown in RAM 504, but many components of such software typically are stored in non-volatile memory also, such as, for example, on data storage 512, such as a disk drive.

The computer 500 of FIG. 5 includes disk drive adapter 516 coupled through expansion bus 518 and bus adapter 508 to processor 502 and other components of the computer 500. Disk drive adapter 516 connects non-volatile data storage to the computer 500 in the form of data storage 512. Such disk drive adapters include Integrated Drive Electronics (‘IDE’) adapters, Small Computer System Interface (SCSI′) adapters, and others as will occur to those of skill in the art. In some implementations, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 500 of FIG. 5 includes one or more input/output (′I/O′) adapters 520. I/O adapters implement user-oriented input/output through, for example, software drivers and computer hardware for controlling output to display devices such as computer display screens, as well as user input from user input devices 522 such as keyboards and mice. The example computer 500 of FIG. 5 includes a video adapter 524, which is an example of an I/O adapter specially designed for graphic output to a display device 526 such as a display screen or computer monitor. Video adapter 524 is connected to processor 502 through a high speed video bus 528, bus adapter 508, and the front side bus 530, which is also a high speed bus.

The exemplary computer 500 of FIG. 5 includes a communications adapter 532 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters 532 implement the hardware level of data communications through which one computer sends data communications to another computer, directly or through a data communications network. Such communication adapters 532 include modems for wired dial-up communications, Ethernet (IEEE 802.3) adapters for wired data communications, and 802.11 adapters for wireless data communications.

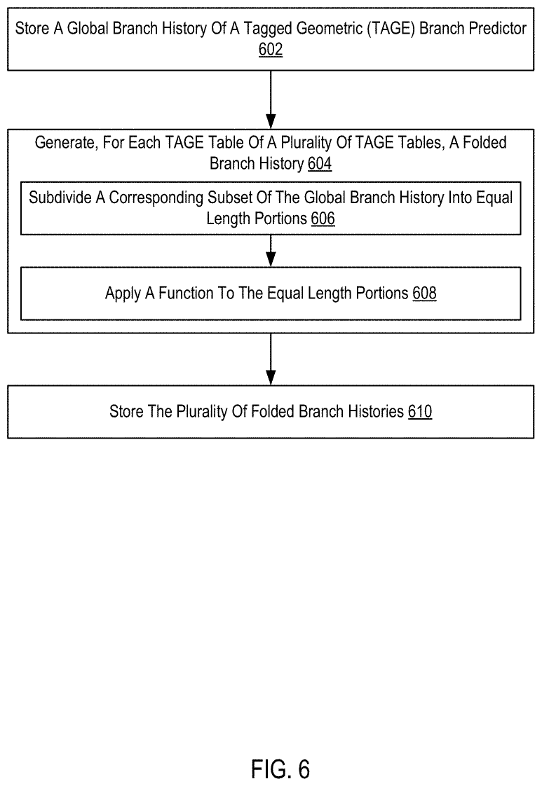

For further explanation, FIG. 6 sets forth a flow chart illustrating an example method for managing large TAGE histories according to some implementations of the present disclosure. The method of FIG. 6 is carried out, for example, in a TAGE branch predictor such as the predictor 102 of FIG. 1 or the predictor 200 of FIG. 2 100. The method of FIG. 6 includes storing 602 a global branch history 206 of a TAGE branch predictor. The global branch history 206 is a data structure or portion of memory including a plurality of entries each indicating whether a branch was taken or not taken. As an example, each entry is a single bit, with a “1” indicating a taken branch and a “0” indicating a non-taken branch. For a global branch history 206 with N entries, the global branch history 206 then stores the N-most recent branch decisions.

The global branch history 206 is encoded, embodied, or implemented as a circular buffer. For example, the global branch history 206 is implemented as an array (such as the array 402 of FIG. 3) of entries. Each entry in the array is a single bit. Instead of shifting entries as with a shift register, the global branch history 206 maintains a head pointer identifying a newest entry in the array and a tail pointer identifying an oldest entry in the array.

The method of FIG. 6 also includes generating 604, for each TAGE table (e.g., 204a-n of FIG. 2) of a plurality of TAGE tables, a folded branch history (e.g., 212a-n of FIG. 2). Each TAGE table is a logical table that includes a plurality of entries. As will be described in further detail below, each TAGE table is indexed based on an increasingly long portion of branch prediction history, with the utilized lengths of branch prediction history increasing according to a geometric sequence. As is shown in the example TAGE table 300 of FIG. 3, each entry of the TAGE table 300 includes a counter 302 and a tag 304. The use of the counter 302 and tag 304 for a given entry in generating the prediction is described in further detail below. Each entry also includes a useful bit 306 that, if set, prevents modification of the corresponding entry.

A folded branch history (e.g., 212a-n of FIG. 2) for a given TAGE table is a representation of the subset of the global branch history used to index the given TAGE table. In some implementations, generating 604 the folded branch history for a given TAGE table includes subdividing 606 a corresponding subset of the global branch history into equal length portions. For example, the equal length portions are each a number of bits required to identify a particular entry in the TAGE table. As an example, assuming a TAGE table with 1024 entries, any entry can be identified using a ten bit number. Accordingly, the subset of the global branch history for that TAGE table is subdivided into ten bit portions. Where the subset of the global branch history is not evenly dividable by the index size, in some implementations, the global branch history is padded (e.g., with one or more zeroes) to generate a global branch history that is a factor of the index size.

Generating 604 the folded branch history also includes applying a function to the equal length portions. In some implementations, the function includes an XOR function. Thus, to generate the folded branch history, each of the portions are XOR-ed together to generate a folded branch history having a number of bits needed to identify an entry in the TAGE table.

The method of FIG. 6 also includes storing 610 the plurality of folded branch histories. Thus, instead of regenerating the folded branch histories at each prediction cycle, the folded branch histories are stored and maintained across prediction cycles, saving the computational and time resources required to generate these folded branch histories.

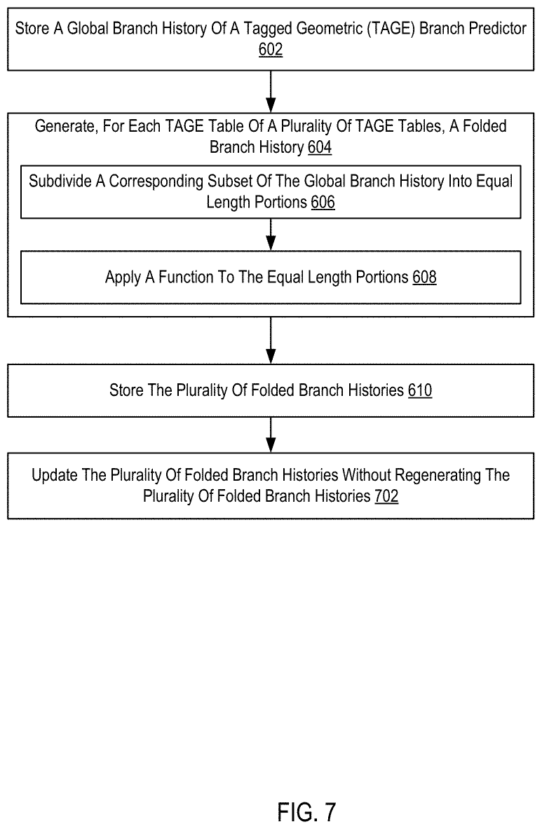

For further explanation, FIG. 7 sets forth a flow chart illustrating another example method for managing large TAGE histories according to implementations of the present disclosure. The method of FIG. 7 also includes updating 702 the plurality of folded branch histories without regenerating the plurality of folded branch histories (e.g., without regenerating the plurality of folded branch histories from the global branch history). For example, assume the global branch history is updated to reflect whether or not a predicted branch was taken. If the folded branch histories are not updated, the previously generated folded branch histories would be out of sync with the global branch history. Instead of regenerating the folded branch histories from the updated global branch history, the stored instances of the folded branch histories are modified to reflect the update (e.g., by shifting the folded branch history, modifying one or more bits in the shifted value, accessing particular bits in the global branch history to calculate particular bits in the folded branch history, etc.).

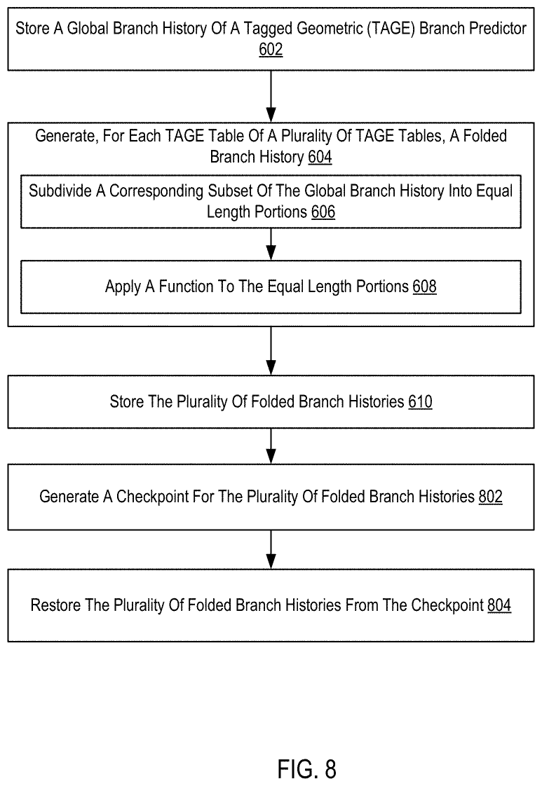

For further explanation, FIG. 8 sets forth a flow chart illustrating another example method for managing large TAGE histories according to implementations of the present disclosure. The method of FIG. 8 also includes generating 802 a checkpoint 803 for the plurality of folded branch histories. A checkpoint 803 is an encoded representation of a state of the folded branch histories for a particular prediction cycle (e.g., a state of the folded branch histories used to generate a prediction for the branch instruction of that prediction cycle). In some implementations, some number of checkpoints 803 are generated and maintained by the TAGE branch predictor (e.g., the N-most recent checkpoints for the N-most recent prediction cycles). In some implementations, the checkpoint 803 encodes the head and tail pointers for the global branch history.

The method of FIG. 8 also includes regenerating 804 the plurality of folded branch histories from the checkpoint 803. For example, in response to a misprediction of a branch instruction, a flush of the instruction pipeline is performed. The checkpoint 803 corresponding to the prediction cycle of that branch instruction is loaded. The values for the folded branch histories in the checkpoint 803 are then copied into the memory used for the folded branch histories. The folded branch histories are then updated to reflect the actually taken path for that branch instruction. In some implementations, head and tail pointers are also updated according to the pointer values in the checkpoint.

In view of the explanations set forth above, readers will recognize that the benefits of managing large TAGE histories include:
Improved performance of a computing system by storing folded branch histories of TAGE tables for subsequent use, saving on computational and power resources used in generating the folded branch histories every prediction cycle.
Improved performance of a computing system by restoring folded branch histories from saved checkpoints in response to a flush, allowing for prediction cycles to quickly resume.

Exemplary implementations of the present disclosure are described largely in the context of a fully functional computer system for managing large TAGE histories. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary implementations described in this specification are oriented to software installed and executing on computer hardware, nevertheless, alternative implementations implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some implementations, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various implementations of the present disclosure. The descriptions in this specification are for purposes of illustration only and are not to be construed in a limiting sense. The scope of the present disclosure is limited only by the language of the following claims.

1. A tagged geometric (TAGE) branch predictor for managing TAGE histories, comprising:
logic that maintains a global branch history comprising a circular buffer;
logic that maintains a plurality of TAGE tables; and
logic that maintains a plurality of folded branch histories, wherein each folded branch history of the plurality of folded branch histories corresponds to a TAGE table of the plurality of TAGE tables, wherein the folded branch histories are each based on different length subsets of the global branch history, wherein the TAGE branch predictor is configured to generate the plurality of folded branch histories by subdividing, for each TAGE table of the plurality of TAGE tables, a corresponding subset of the global branch history into equal length portions, wherein a length of the equal length portions for each TAGE table corresponds to a number of bits used to identify an entry in the TAGE table.

2. The TAGE branch predictor of claim 1, wherein the TAGE branch predictor is further configured to generate the plurality of folded branch histories by:
generating, for each TAGE table of the plurality of TAGE tables, a corresponding folded branch history by applying a function to the equal length portions.

3. The TAGE branch predictor of claim 2, wherein the function comprises an XOR function.

4. The TAGE branch predictor of claim 1, wherein the TAGE branch predictor is configured to update the plurality of folded branch histories without regenerating the plurality of folded branch histories from the global branch history.

5. The TAGE branch predictor of claim 1, wherein the TAGE branch predictor is configured to generate, for a branch prediction cycle, a checkpoint for the plurality of folded branch histories.

6. The TAGE branch predictor of claim 5, wherein the TAGE branch predictor is further configured to restore, in response to a flush for the branch prediction cycle, the plurality of folded branch histories based on the checkpoint.

7. The TAGE branch predictor of claim 1, wherein the different length subsets of the global branch history are of geometrically increasing length.

8. A method of managing TAGE histories, the method comprising:
storing a global branch history of a tagged geometric (TAGE) branch predictor comprising a circular buffer;
generating, for each TAGE table of a plurality of TAGE tables, a folded branch history of a plurality of folded branch histories, wherein the folded branch histories are each based on different length subsets of the global branch history, wherein generating the plurality of folded branch histories comprises subdividing, for each TAGE table of the plurality of TAGE tables, a corresponding subset of the global branch history into equal length portions, wherein a length of the equal length portions for each TAGE table corresponds to a number of bits used to identify an entry in the TAGE table; and
storing the plurality of folded branch histories.

9. The method of claim 8, wherein generating the plurality of folded branch histories further comprises:
generating, for each TAGE table of the plurality of TAGE tables, a corresponding folded branch history by applying a function to the equal length portions.

10. The method of claim 9, wherein the function comprises an XOR function.

11. The method of claim 8, further comprising updating the plurality of folded branch histories without regenerating the plurality of folded branch histories from the global branch history.

12. The method of claim 8, further comprising generating, for a branch prediction cycle, a checkpoint for the plurality of folded branch histories.

13. The method of claim 12, further comprising restoring, in response to a flush for the branch prediction cycle, the plurality of folded branch histories based on the checkpoint.

14. The method of claim 8, wherein the different length subsets of the global branch history are of geometrically increasing length.

15. An apparatus for managing TAGE histories, comprising:
computer memory;
a processor operatively coupled to the computer memory, the processor comprising a TAGE branch predictor comprising:
logic that maintains a global branch history comprising a circular buffer;
logic that maintains a plurality of TAGE tables; and
logic that maintains a plurality of folded branch histories, wherein each folded branch history of the plurality of folded branch histories corresponds to a TAGE table of the plurality of TAGE tables, wherein the folded branch histories are each based on different length subsets of the global branch history, wherein the TAGE branch predictor is configured to generate the plurality of folded branch histories by subdividing, for each TAGE table of the plurality of TAGE tables, a corresponding subset of the global branch history into equal length portions, wherein a length of the equal length portions for each TAGE table corresponds to a number of bits used to identify an entry in the TAGE table.

16. The apparatus of claim 15, wherein the TAGE branch predictor is further configured to generate the plurality of folded branch histories by:
generating, for each TAGE table of the plurality of TAGE tables, a corresponding folded branch history by applying a function to the equal length portions.

17. The apparatus of claim 16, wherein the function comprises an XOR function.

18. The apparatus of claim 15, wherein the TAGE branch predictor is configured to update the plurality of folded branch histories without regenerating the plurality of folded branch histories from the global branch history.

19. The apparatus of claim 15, wherein the TAGE branch predictor is configured to generate, for a branch prediction cycle, a checkpoint for the plurality of folded branch histories.

20. The apparatus of claim 19, wherein the TAGE branch predictor is further configured to restore, in response to a flush for the branch prediction cycle, the plurality of folded branch histories based on the checkpoint.
